(19) United States
(12) Patent Application Publication
(10) Pub. No.: US 2023/0039827 A1
(43) Pub. Date: Feb. 9, 2023

(54) TOOL FOR BUSINESS RESILIENCE TO DISASTER

(71) Applicant: One Concern, Inc., Menlo Park, CA (US)

(72) Inventors: Ahmad Wani, Mountain View, CA (US); Nicole Hu, Mountain View, CA (US); Chengwei Zhai, Menlo Park, CA (US); Deepak Pant, Menlo Park, CA (US); Jaskanwal Chhabra, Menlo Park, CA (US); Lynne Burks, Menlo Park, CA (US); Michael Chapman, Menlo Park, CA (US); Ojas Rege, Menlo Park, CA (US); Abhineet Gupta, Menlo Park, CA (US); Shabaz Patel, Menlo Park, CA (US); Youngsuk Kim, Menlo Park, CA (US)

(21) Appl. No.: 17/393,693

(22) Filed: Aug. 4, 2021

(51) Int. Cl. G06Q 10/06; G06F 11/00; G06F 3/0482

(52) U.S. Cl. CPC G06Q 10/06375; G06F 3/0482; G06F 11/008; G06Q 10/0635

(57) ABSTRACT

Methods, systems, and computer programs are presented for estimating downtime and recovery time after a disaster. One method includes an operation for calculating component fragility functions for components of a facility that are vulnerable to damage after a disaster. Further, the method includes calculating component recovery functions for the components of the facility. The component recovery functions indicate a probability of recovery after a disaster over time. The method further includes operations for calculating a facility fragility function and a facility recovery function based on the component fragility functions and the component recovery functions, and for determining a downtime for the facility for a given intensity associated with the disaster. Further, the method includes an operation for causing presentation of the downtime for the facility on a user interface (UI).

### CROSS-REFERENCE TO RELATED APPLICATIONS

This application is related to U.S. Pat. Application No. 17/239,928, entitled "Estimation of Distribution Network Recovery After Disaster," filed on Apr. 26, 2021, and is herein incorporated by reference in its entirety.

### TECHNICAL FIELD

The subject matter disclosed herein generally relates to methods, systems, and machine-readable storage media for planning to overcome the effects of disasters.

### BACKGROUND

Natural disasters, such as earthquakes, storms, tropical cyclones, floods, etc., create disruptions to business operations in the area impacted by the disaster. Businesses want to plan for the impact of disasters, which includes understanding the damage caused by the disasters and how to recover to restore business operations.

The problem of estimating downtime in one facility is complicated because the estimation needs to account not only for the restoration of the structure of the building, but also for other related factors, such as downtime of power or water systems, downtime in other facilities that provide support (e.g., raw materials), availability of workers to return to work, etc., and their interdependencies. For example, if the power returns to the facility, but the workers cannot get to work because public transportation is unavailable or roads are blocked, then the business will not be able to operate.

### BRIEF DESCRIPTION OF THE DRAWINGS

Various of the appended drawings merely illustrate example embodiments of the present disclosure and cannot be considered as limiting its scope.

FIG. 1 is a user interface (UI) for showing facilities involved in the operation of a business, according to some example embodiments.

FIG. 2 is a UI for showing details in a selected region, according to some example embodiments.

FIG. 3 is a UI for selecting disaster-related parameters, according to some example embodiments.

FIG. 4 is a UI for configuring mitigation measures, according to some example embodiments.

FIG. 5 is a table summarizing disaster planning factors, according to some example embodiments.

FIG. 6 illustrates the framework for resilience planning, according to some example embodiments.

FIG. 7 is a flowchart for estimating recovery after a disaster, according to some example embodiments.

FIG. 8 is a chart showing the distribution of recovery time after a disaster, according to some example embodiments.

FIG. 9 shows the use of fragility and recovery curves for estimating recovery times, according to some example embodiments.

FIG. 10 shows an example for estimating the recovery time of a building, according to some example embodiments.

FIG. 11 shows an example for calculating downtime of the power distribution network, according to some example embodiments.

FIG. 12 illustrates the use of an exceedance curve for estimating downtime, according to some example embodiments.

FIG. 13 is an example of calculating downtime for roads and bridges, according to some example embodiments.

FIG. 14 is an example of calculating downtime for human resources, according to some example embodiments.

FIG. 15 is a flowchart for estimating the impact to lifelines after a disaster, according to some example embodiments.

FIG. 16 is an example of the use of fragility functions for shipping ports, according to some example embodiments.

FIG. 17 shows the estimating of recovery times for ports in different countries, according to some example embodiments.

FIG. 18 is a flowchart of a method for estimating downtime and recovery time after a disaster, according to some example embodiments.

FIG. 19 is a block diagram illustrating an example of a machine upon or by which one or more example process embodiments described herein may be implemented or controlled.

### DETAILED DESCRIPTION

Example methods, systems, and computer programs are directed to estimating downtime and recovery time after a disaster. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

One general aspect includes a method that includes an operation for calculating component fragility functions for components of a facility that are vulnerable to damage after a disaster. Further, the method includes calculating component recovery functions for the components of the facility. The component recovery function indicates a probability of recovery after a disaster over time. The method further includes operations for calculating a facility fragility function and a facility recovery function based on the component fragility functions and the component recovery functions, and for determining a downtime for the facility for a given intensity associated with the disaster. Further, the method includes an operation for causing presentation of the downtime for the facility on a user interface (UI).

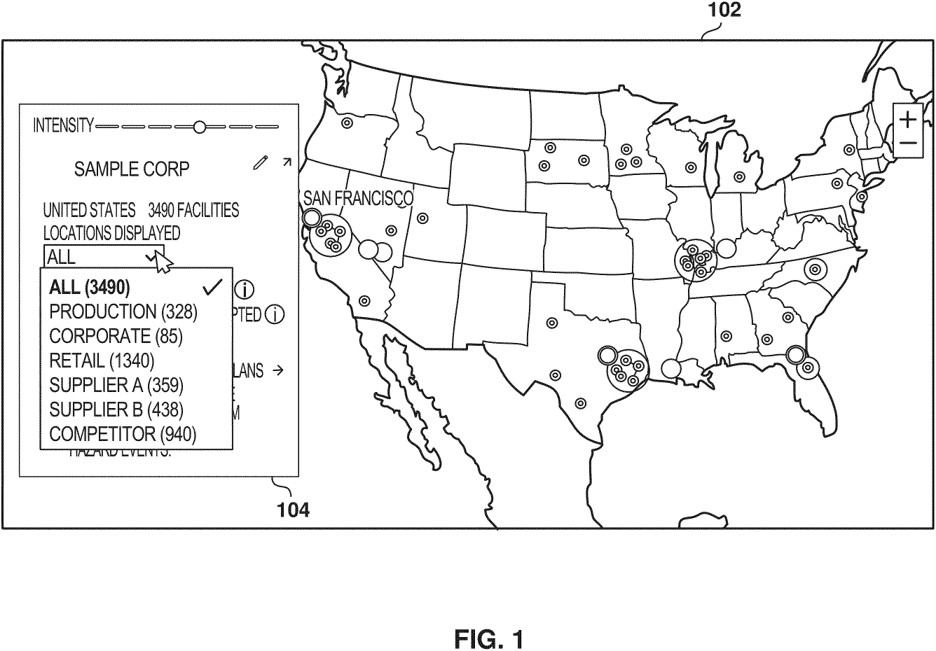

FIG. 1 is a user interface (UI) 102 for showing facilities involved in the operation of a business, according to some example embodiments. Large corporations are usually dispersed over a number of locations and their operations depend on the activities performed at these locations. Locations include not only the corporation's facility, but also related locations, such as suppliers, distributors, retailers, government facilities, employee housing, etc.

The smooth operation of the corporation depends on the proper operation of all these locations. Any disruption to the locations (e.g., flooding at a supplier's building) will cause disruptions in the business functions.

The UI 102 shows the locations that are associated with the operations for a sample corporation named Sample Corp. The UI 102 provides options for zooming on the map to a smaller region or to select locations for certain categories, such as the categories shown in window 104 for selecting the locations. The options include selecting locations for all, production, corporate, retail, a first supplier, a second supplier, and a competitor. In the illustrated example, Sample Corp has 3490 locations that affect its business.

The UI 102 includes options for performing vulnerability analysis to the occurrence of hazards, e.g., earthquakes, floods, tornadoes, hurricanes, wildfires, etc., at a certain place, and the UI 102 presents the impact of the hazard on the corporation's locations. For example, the UI 102 indicates which assets will be impacted and the estimated time for recovery to fix or replace the assets and return to normal operations.

The UI 102 also provides options for mitigating the impact of disasters, such as having backup power, reinforcing buildings, etc., and seeing how the mitigation measures will affect downtime and the cost of fixing the assets.

The system includes a digital twin for the buildings and other infrastructure such as roads, bridges, ports, and airports in the selected area (e.g., the whole country, a state), and the analysis determines how a disaster would impact each of these by modeling the damage using the digital twin.

For example, the analysis may determine that 49 buildings are vulnerable to flooding after a certain amount of water poured on the terrain by rain. When the vulnerabilities are found, the UI 102 shows the vulnerable locations in a highlighted fashion (e.g., red color, bold names, circles around the locations, or a combination thereof).

Once the vulnerable facilities are identified, the system determines which other facilities will be affected. For example, if the warehouse of a distributor is flooded, the corporation will not be able to ship products to retailers in certain areas.

Additionally, the UI 102 provides options for comparing the effect of a disaster on different types of assets. For example, what would be the effect on a first supplier versus a second supplier, what would be the effect on a competitor, what would be the effect on a customer.

The information may also be used for risk analysis. For example, a bank may analyze the effect of a disaster on companies that have loans with the bank, and the effect may be used to analyze the risk of those loans.

Further, the UI 102 includes options for the type of hazard and for climate change, that is, how will the buildings and other infrastructure be affected by the occurrence of a certain hazard, and adjusting the damage based on climate-change parameters.

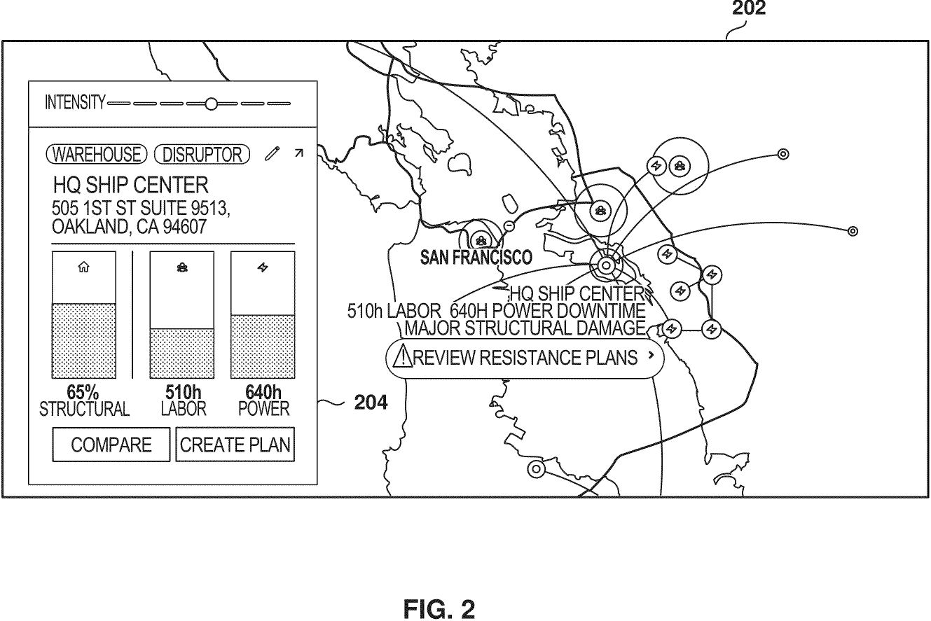

FIG. 2 is a UI 202 for showing details in a selected region, according to some example embodiments. After the user selects a region on the UI 102 shown in FIG. 1, the UI 202 is presented showing the facilities in a smaller region, which, in this example, is the San Francisco Bay Area.

If the user selects one of the locations, then window 204 shows information about the downtime for that location (e.g., name and address), and information about downtime for the structural damage, labor shortages, and power shortages. Other embodiments may present additional information.

The information presented is more than just identifying the damage at the location, but also the business disruption caused by the damage on other locations, employees, roads and bridges, transportation hubs (e.g., ports and airports), etc. The result is identifying expected downtime at the location, which is affected by multiple factors.

As used herein, lifelines refer to utilities used by the facility and the downtime is affected by multiple lifelines, such as power, water, telecommunications (e.g., telephone landlines, mobile phone infrastructure, wired Internet access), transportation (e.g., roads, bridges, port hubs, airports), etc.

For example, one of the biggest business disruptors in the U.S. in the last twenty years was the strike at the Los Angeles port, which affected many businesses that relied on products or parts that flowed through the port.

Companies need people to run the business, so the planning tool also considers the effect on business operations due to the inability of employees to get to work, e.g., lost housing, lost car, lost power at their homes, roads are not available. Thus, a building may survive unaffected by an earthquake, but if employees cannot come to work the next day, then there will be a business interruption.

Thus, the UI 202 shows information about lifelines, such as bridges' downtime, power outages, airports' downtime, etc.

The UI 202 also provides the ability to select multiple locations and compare the effects of the disaster. In some example embodiments, several windows 204 are presented for multiple locations so the user is able to compare the downtime factors at the multiple sites.

The UI 202 also provides the option of zooming in further into a particular location, such as showing the map at the street level. Further, the map may also be shown in a 3D view of the area.

With regards to hazards, the UI 202 provides options to select a hazard (e.g., wind, flood, fire, earthquake, tornado) and the intensity of the hazard, either specified by the user in terms of a return period or by using a historical event, such as a previous earthquake in the area. Once the hazard is defined, a simulation takes place, and the system calculates the impact on the building facilities and other infrastructure throughout the region.

Further, the UI 202 provides an option to define the planning horizon to determine the probability of damage and facility downtime within a certain timeframe, such as what is the expected downtime because of earthquakes that may occur within the next 10 years. The system determines the probability of different events over the time period and calculates the possible downtime for the business.

The user may also perform a simulation for a certain return period, which is the number of years, on an average, it would take for an event of a certain intensity threshold to occur (e.g., 100-year return period). The return period is based on the probability of the event taking place over a given duration. For example, a ten percent probability to occur in 50 years corresponds to a 500-year return period, and a one percent probability in ten years corresponds to a 100-year return period.

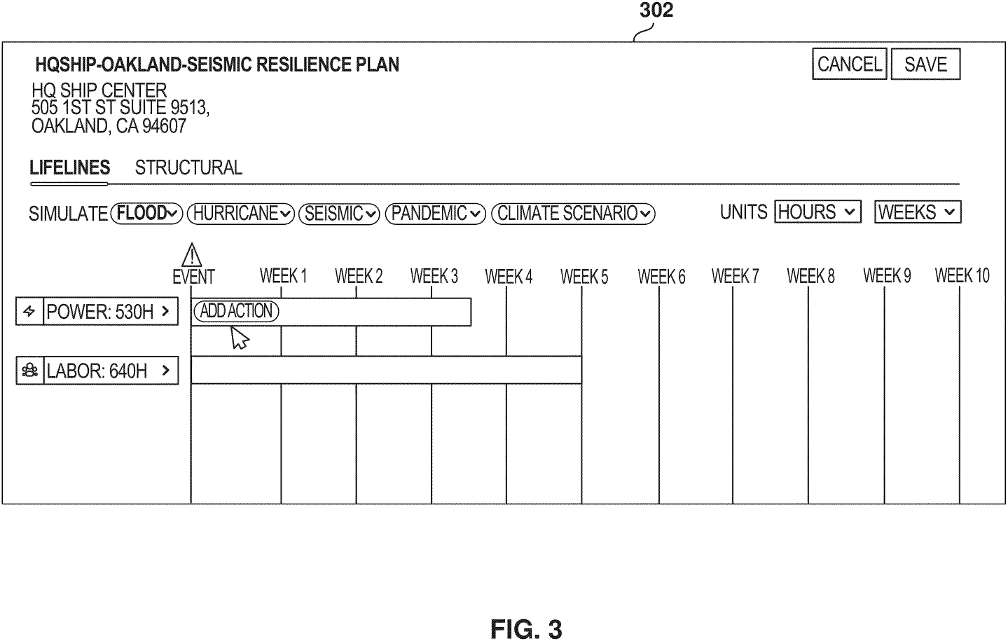

FIG. 3 is a UI 302 for selecting disaster-related parameters, according to some example embodiments. In some example embodiments, the parameters for the simulation include selecting flood, hurricane, seismic, pandemic, or climate scenarios, but other embodiments may include additional or fewer parameters.

Once the user selects the parameters for the simulation, a resilience tool presents the estimated downtime for the facility or some of the lifelines and transportation hubs. The resilience tool is a system for managing risk, and it provides tools and user interfaces for estimating risk to business operations for multiple types of hazards over predefined time periods. In the illustrated example, the UI 302 presents the downtime for power (e.g., estimated at 530 hours), and for labor (e.g., estimated 640 hours).

Additionally, the UI 302 provides an option to select a mitigation action (e.g., add battery power) and then see how the mitigation action would affect the downtime.

For climate change, the user can select from multiple options, such as temperature rising two degrees over the next twenty years, or rising three degrees, etc. The simulation then takes into account the climate change horizon to estimate downtime over the planning horizon.

A resilience plan includes remedial actions that an organization can take to reduce the downtime due to potential disasters. The resilience tool provides an option to add the remedial actions and then show how those remedial actions would decrease damage and downtime. Further, the remedial actions are given a cost, which is compared to the potential benefit in lower damage and reduced downtime.

In some example embodiments, the resilience plan is defined for a given location and associated with a given scenario (e.g., an earthquake). In other embodiments, the resilience plan covers multiple locations and multiple scenarios. By adding remedial actions, an organization is able to manage the level of risk for given vulnerabilities.

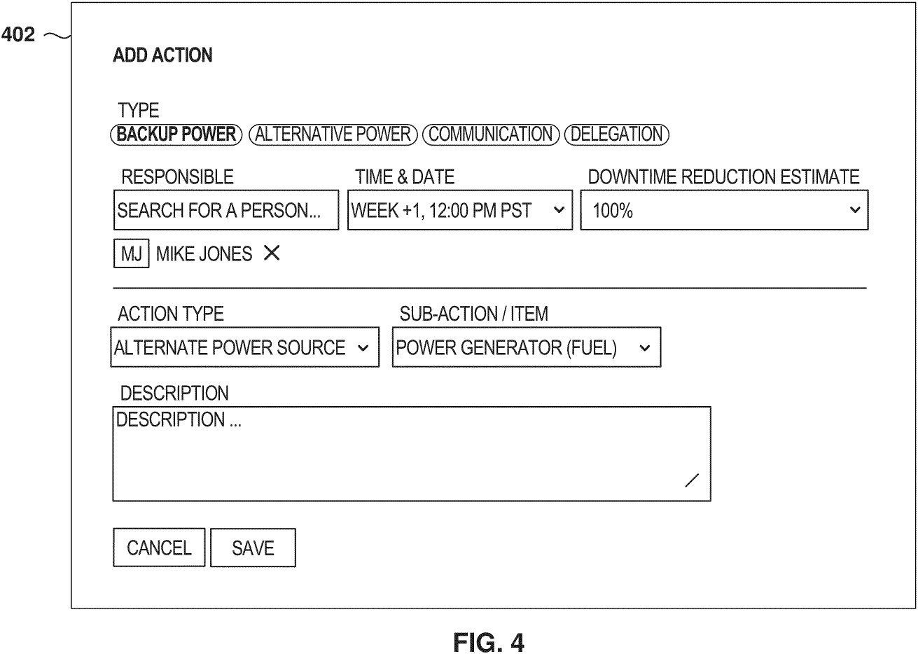

FIG. 4 is a UI 402 for configuring mitigation measures, according to some example embodiments. In the illustrated example, the mitigation actions available to the user include adding backup power, adding an alternative power source, adding communications, and adding delegation of tasks. In the illustrated example, the user has selected adding backup power using a power generator.

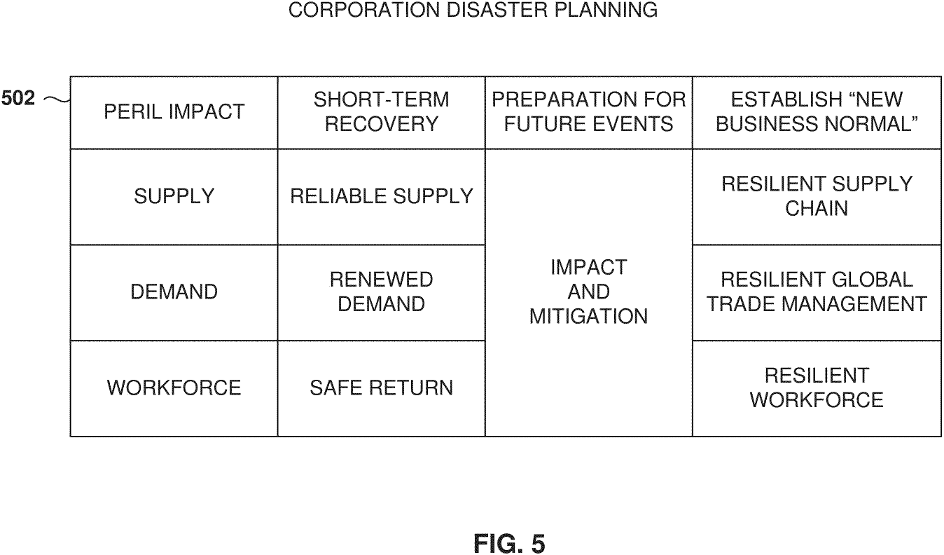

FIG. 5 is a table 502 summarizing disaster planning factors, according to some example embodiments. The first column is for the peril impact and the rows correspond to the impact on supply, demand, and workforce.

The second column is for planning short-term recovery after a disaster, which includes obtaining reliable supply, renewing the demand, and the safe return of the workforce to work.

The third column is for planning for future events, which includes impact of disaster and possible mitigation actions, for all three areas of supply, demand, and the workforce.

The fourth column is for long-term planning to establish the so-called "new business normal," which includes going back to full operation after the disaster. This fourth column includes building a resilient supply chain, a resilient global trade management system, and a resilient workforce.

The resilience planning includes determining the probability of damage and the estimated functional downtime if damage occurs. For example, calculating the probability of damage to the facility in the probability of damage to housing and power for the workforce, and probability of damage to the region's infrastructure. The cumulative risk for a given planning horizon is computed, which includes aggregating the risk across a plurality of possible hazards.

The planning horizon determines the accumulated downtime/damage over a certain planning time period (e.g., five years, 10 years, 20 years) considering the probability of all the risks during this period.

To calculate damage that affects the workforce, a radius around the facility is defined (e.g., 30 miles, 50 miles), and the employee availability is calculated based on the probability that the workforce is situated within the defined radius. Statistical analysis is then performed to generate estimates for the workforce as a group to identify the availability of people to work at the facility.

In some example embodiments, calculating damages for the infrastructure includes calculating probability of damage and downtime for the power grid, roadways (including bridges and tunnels), and shipping ports and airports. For the community, the damages are calculated for hospitals, government facilities, grocery stores, and other essential facilities.

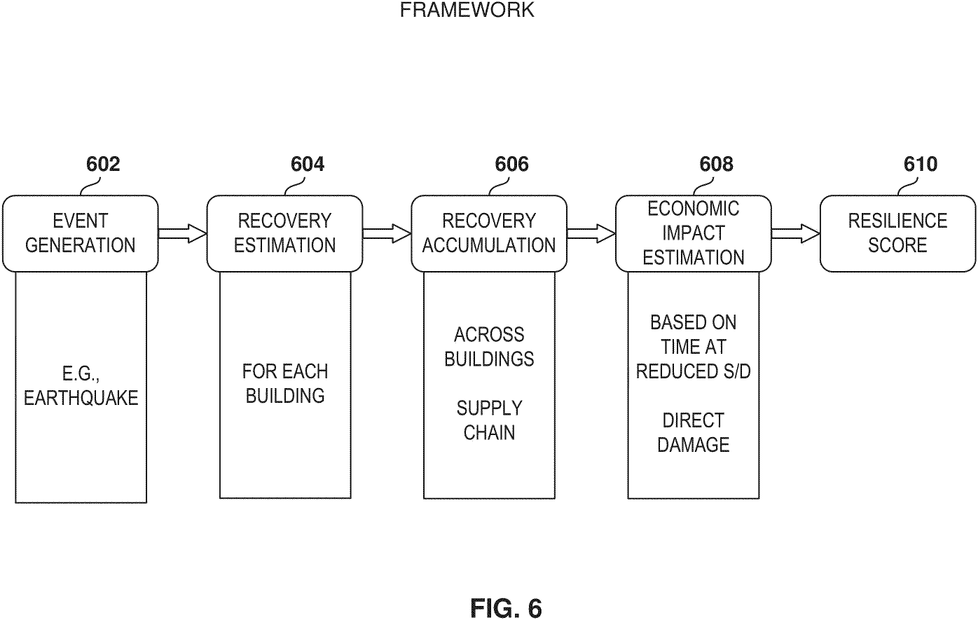

FIG. 6 illustrates the framework for resilience planning, according to some example embodiments. Resilience planning includes operation 602 for generating an event for the simulation, such as earthquake, flood, fire, pandemic, hurricane, etc.

Based on the event, simulation is performed to determine damage and an estimate for the recovery time 604. In some example embodiments, the recovery is calculated for the buildings in the area of interest (e.g., within 50 miles from the facility).

At operation 606, the recovery parameters are accumulated for all the facilities associated with the organization, including the buildings associated with the supply chain and the buildings associated with the distribution of goods.

At operation 608, the economic impact of the event is estimated, based on the time spent operating with constrained supply and demand, and includes calculating the direct damage caused by the event.

At operation 610, a resilience score is calculated for the organization. The resilience score is a number that indicates how resilient to a disaster a facility, a group of facilities, or a complete organization, are, where the higher the resilience score, the less impact the disaster event will have on the organization.

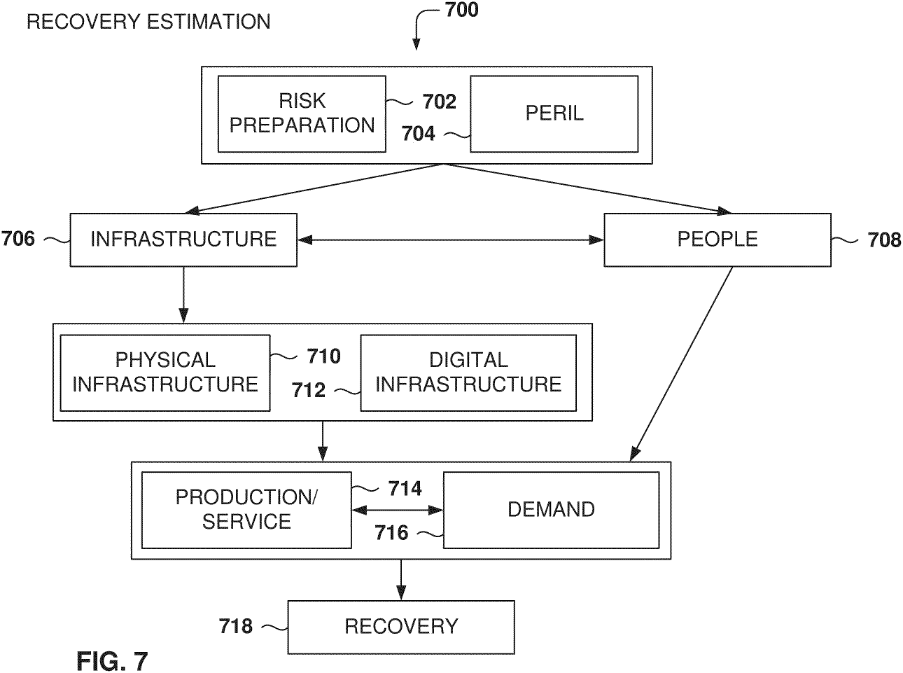

FIG. 7 is a flowchart 700 for estimating recovery after a disaster, according to some example embodiments. Risk preparation and risk avoidance 702 cover the measures to handle risk, and include setting policies and regulations, retrofitting or reinforcing buildings, performing operational drills, business continuity planning (BCP), putting mitigation measures in place, obtaining business continuity insurance, etc. Peril 704 includes the list of possible hazards that can disrupt the business operation. Risk preparation and risk avoidance 702 and peril 704 are inputs for how the business would recover from a disaster.

Infrastructure 706 includes physical infrastructure 710 and digital infrastructure 712. The physical infrastructure 710 includes tangible physical elements to operate the business and includes buildings, equipment, lifelines (e.g., utilities power, water, gas), telecom, transportation, physical ambiance factors (e.g., presence of hazardous materials), etc.

The digital infrastructure 712 includes the assets and services for the communications and operation of the computer equipment of the business, and includes data centers, cloud services, software used for operations, IoT devices, robots, machinery, sensors, user devices (e.g., laptops, mobile phones), etc.

People 708 refers to the ability of people to perform their normal functions in society, and includes physical health, mental health, economic well-being, availability of the workforce, socio-economic factors, etc.

The recovery estimation includes modeling that affects the workforce, such as workers' homes being damaged; workers having access to food, water, and electricity; a pandemic; etc.

A production and services module 714 estimates the impact on the factors that affect production. The demand 716 is based on the ability of the community and customers to be willing and able to purchase goods or use services. The customers can be businesses, consumers, or government organizations.

Finally, the recovery time 718 is estimated based on the simulations performed based on the factors and inputs mentioned above.

In some example embodiments, the recovery accumulation includes combining the supply-chain resilience with the portfolio resilience. For the supply-chain resilience, the impact for the suppliers is accumulated to obtain the production resilience. In another example, the facility resilience includes combining the resilience of multiple buildings involved in the manufacturing and distribution.

In one example for a vehicle manufacturer, there are three main components from a variety of suppliers that provide parts, the workforce that works at the factory and other company buildings, and the manufacturing facility. The facility includes warehouses, manufacturing plants, and administrative buildings. The lifelines for the business include power, water, gas, and transportation.

Additionally, the government regulations regarding the manufacturing and selling of vehicles are applied to the environment for the simulations. Once the environment is configured, the recovery estimation is performed for the vehicle manufacturer and the resilience plan is analyzed to determine the level of risk and possible mitigating actions.

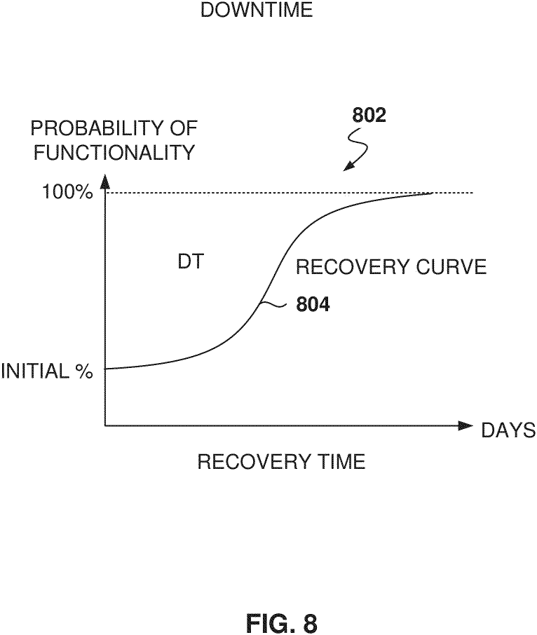

FIG. 8 is a chart 802 showing the distribution of recovery time after a disaster, according to some example embodiments. The chart 802 includes a recovery curve 804 which describes the relationship between time (e.g., days in the horizontal axis) and probability functionality of the facility (times 100) (from zero to one hundred percent in the vertical axis).

The illustrated example shows that a facility is operating at a 100% functionality with a certain initial probability (less than 100%), and over time the probability to operate at 100% functionality increases until it reaches one hundred percent again. The average downtime of the facility is the area between the recovery curve and the line parallel to the x-axis with ordinate equal to 100%.

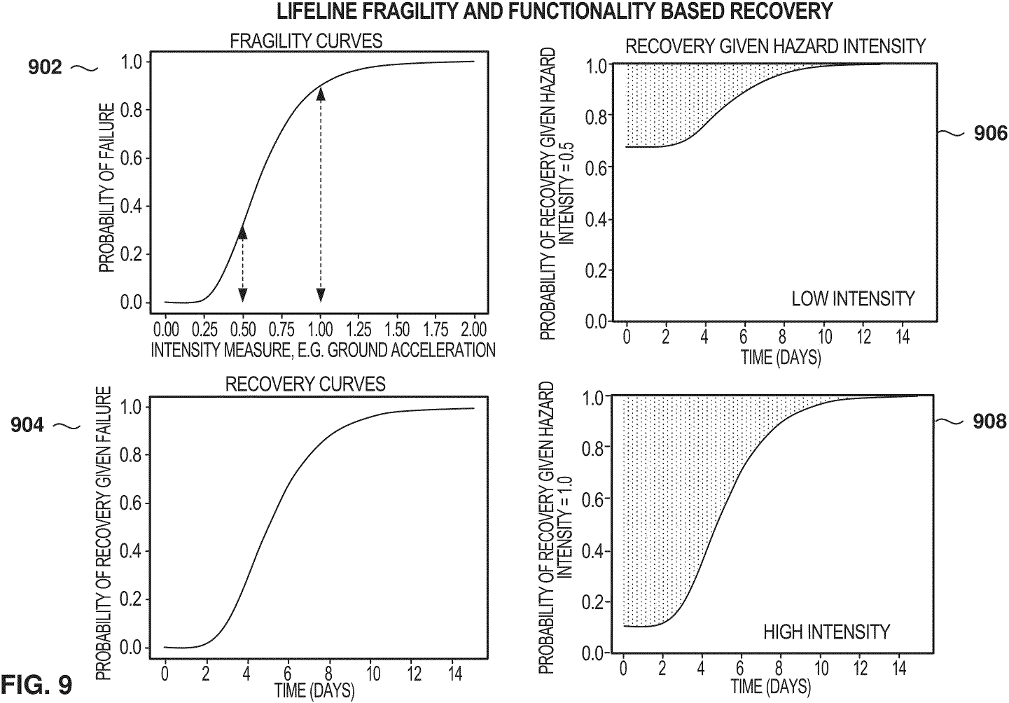

FIG. 9 shows the use of fragility curve 902 for estimating damage, according to some example embodiments. The fragility curve 902 describes the probability that something will fail (vertical axis) based on the intensity of an event (e.g., earthquake shaking, flood level, rainfall, wind speed).

A recovery curve 904 shows the probability of recovery given failure, with the horizontal axis as the time to recovery, and the vertical axis as the probability of recovery.

The recovery-given-hazard intensity curves 906, 908 indicate the probability of recovery of an asset (vertical axis) as a function of time for a certain hazard intensity. The recovery-given-hazard intensity curves 906, 908 integrate the chances of failure and the chances of recovery. The recovery-given-hazard intensity curve 906 is for a low-intensity event and the recovery-given-hazard intensity curve 908 is for a high-intensity event (e.g., an earthquake of high shaking). Thus, recovery-given-hazard intensity curve 906 shows that the probability of full recovery over time is much faster for a low-intensity event compared with that for a high-intensity event as shown in curve 908. For example, both curves show that the recovery curve extends up to around 12 days, but recovery-given-hazard intensity curve 906 shows that the probability of recovery on any given day is much higher than that in the case of recovery-given-hazard intensity curve 908.

The average downtime for the event is the area above the recovery curve. Thus, the downtime associated with recovery-given-hazard intensity curve 906 is much smaller than the downtime associated with recovery-given-hazard intensity curve 908.

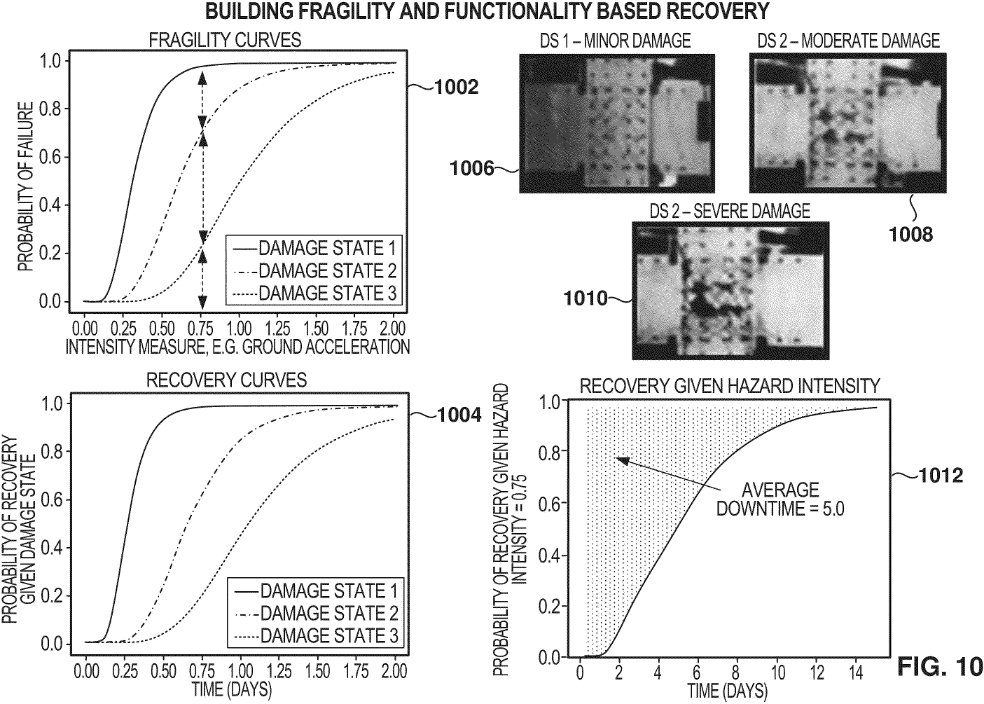

FIG. 10 shows an example for estimating the recovery time of a building, according to some example embodiments. In the illustrated example, fragility curves 1002 are associated with the building. There are three fragility curves 1002, each fragility curve associated with a damaged state (e.g., minor damage 1006, moderate damage 1008, and severe damage 1010).

Also associated with the building, recovery curves 1004 are available for each of the three damaged states. It is noted that other embodiments may include a different number of damaged states, such as in the range from 1 to 5 or more.

The different levels of damage are associated with different repair times, and that is why the recovery curves are different depending on the damaged state.

The information of the fragility curves 1002 and the recovery curves 1004 is combined to obtain the recovery-given-hazard-intensity curve 1012 which indicates the probability of recovery given the hazard as a function of time (e.g., number of days on the horizontal axis). That is, the information (e.g., probabilities) for the different damaged states is combined into a single recovery-given-hazard-intensity curve 1012 based on the hazard intensity.

In some example embodiments, the fragility curves are calculated by using Monte Carlo simulations based on probabilities of damage according to the hazard intensity. Monte Carlo simulations are used to model the probability of different outcomes in a process that cannot easily be predicted due to the intervention of random variables.

A Monte Carlo simulation performs analysis by building models of possible results by substituting a range of values-a probability distribution-for any factor that has inherent uncertainty. The simulation then calculates results many times, each time using a different set of random values from the probability functions. Depending upon the number of uncertainties and the ranges specified for them, a Monte Carlo simulation could involve thousands or tens of thousands of recalculations before it is complete. A Monte Carlo simulation produces distributions of possible outcome values.

The Monte Carlo simulation often follows the following operations: 1) define a domain of possible inputs; 2) generate inputs randomly from a probability distribution over the domain; 3) perform a deterministic computation on the inputs; and 4) aggregate the results.

In some example embodiments, the recovery curves 1004 are calculated based on the review of past events. For example, how long did it take for this building to recover after a flood with one-meter flood level.

The recovery-given-hazard-intensity curve 1012 is calculated based on the fragility curves 1002 and the recovery curves 1004 by determining, based on the hazard intensity, what is the probability that the building will recover in a certain amount of time.

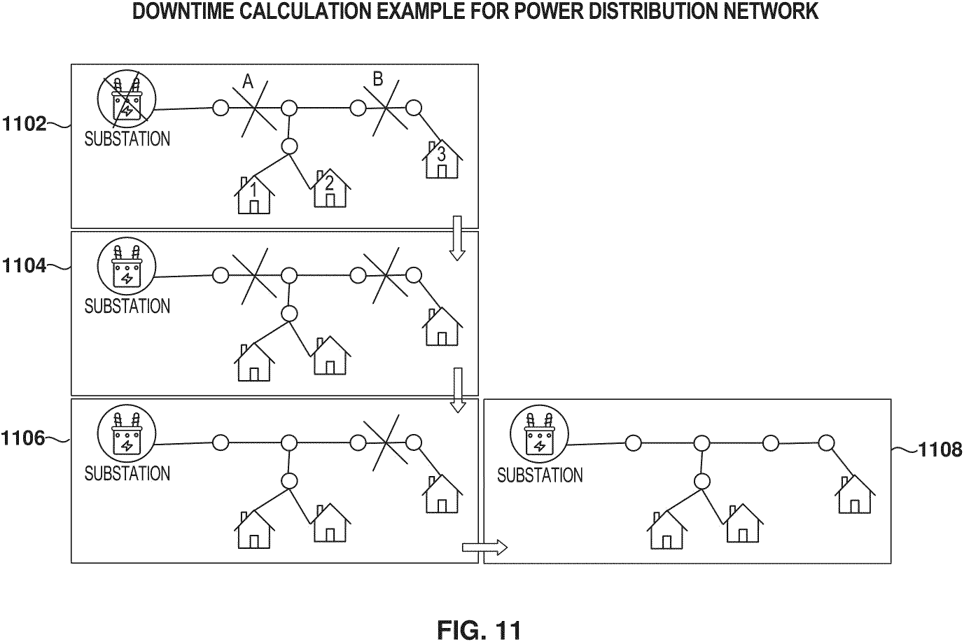

FIG. 11 shows an example for calculating downtime of the power distribution network, according to some example embodiments. The illustrated example shows the recovery process after a power failure in the grid caused by a disaster.

At time 1102, a substation and power lines are down, causing power disruption to multiple homes and businesses. In some example embodiments, repairing the substation is the first priority, and time 1104 shows the substation being repaired. After repairing the substations, the repair crews focus on repairing the power lines, prioritizing the repairs based on the number of households and businesses affected by each powerline.

At time 1106, one of the power lines is repaired, and then, at time 1108, the second power line is repaired to complete service throughout the grid. More details, on the process for simulating the recovery of the power grid and estimating downtime, are provided on U.S. Pat. Application No. 17/239,928, entitled "Estimation of Distribution Network Recovery After Disaster."

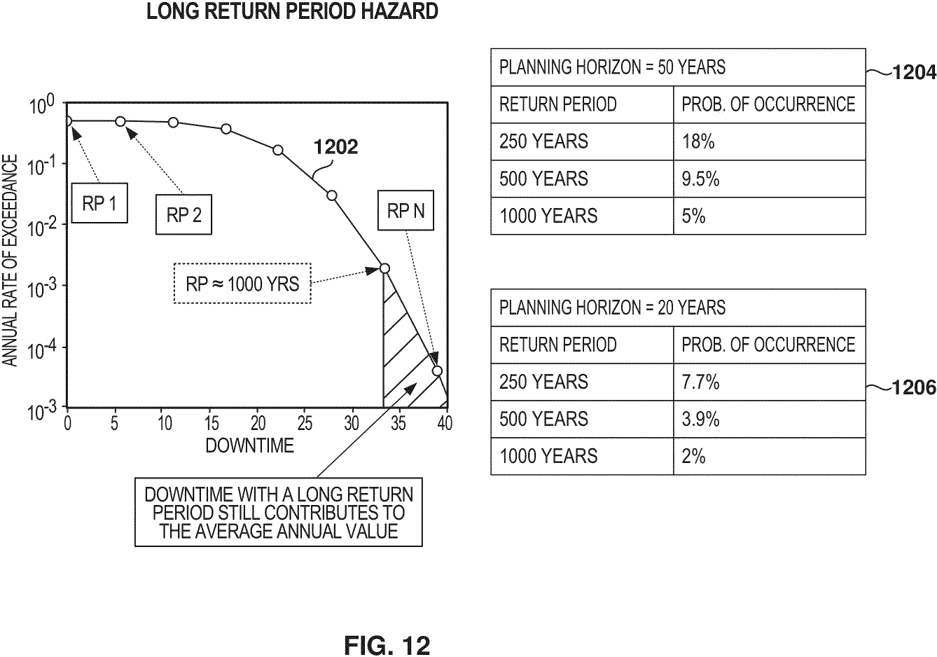

FIG. 12 illustrates the use of an exceedance curve (EC) 1202 for estimating downtime, according to some example embodiments. The EC 1202 visually displays the probability that loss will exceed some amount within some period of time, that is, the EC 1202 describes the probability that various levels of loss will be exceeded.

The return period, also known as a recurrence interval or repeat interval, is the average time between events, e.g., earthquakes, floods, landslides, floods. The return period is a statistical measurement typically based on historic data over an extended period. For relatively higher return periods, the inverse of the return period is the probability that the corresponding event will occur in a given year.

For the exceedance curve 1202, the horizontal axis corresponds to a metric of interest, such as downtime after a disaster (e.g., substation). The vertical axis is the annual rate of exceedance, e.g., the inverse of the return period. The dots along the exceedance curve 1202 represent the different return periods.

Calculating downtime is usually a complex process, which varies according to the element that will suffer downtime, such as buildings, power stations, power lines, roads, bridges, etc.

The planning horizon is a period of time being used for estimating the risk. For example, a firm may want to assess the risk over a planning horizon of twenty years, so the estimation takes into account this planning horizon to determine relevant parameters, such as downtime and probability of a disaster occurring.

In some example embodiments, the downtime over the planning horizon is calculated as the number of years in the planning horizon times the average annual downtime. For example, if the average annual downtime is five hours, then, over the planning horizon of ten years, the downtime would be equal to five times ten, which is fifty.

It is noted that the term “100-year flood" is often understood that the flood which happened precisely once per century. This is a common misconception because it doesn't mean that 100 years should pass between floods. Rather, the term "100-year flood" refers to an event that has a 1% probability of occurring in any given year.

Tables 1204 and 1206 show examples of return periods and probability of occurrence of the event for planning horizons of fifty and twenty years.

Return periods can be very long. For example, an earthquake may have a 2500-year return period, which makes it a rare event, but its occurrence is still considered when designing structures because there is non-zero probability of the earthquake happening.

Tables 1204 and 1206 show that, even when considering a short planning horizon, long return periods (e.g., 1000 years) are still taken into consideration.

Once the EC 1202 is calculated, the average annual downtime is calculated based on the area under the EC 1202. For example, a company may plan for five hours of downtime each year.

Climate change may affect the probability of occurrence of some disasters, such as flood, wind, and fire. In some example embodiments, climate change is taken into consideration over the planning. One or more ECs with climate change are calculated and each EC is based on a certain amount of temperature change.

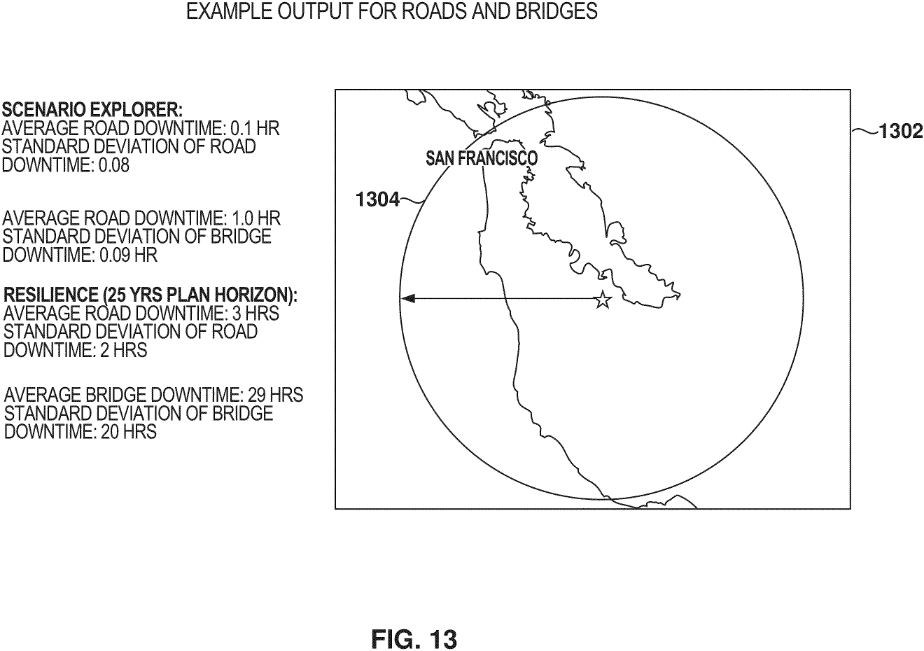

FIG. 13 is an example of calculating downtime for roads and bridges, according to some example embodiments. In other example embodiments, other assets may also be considered, such as airports and location of employee residences.

The map 1302 is centered around the facility of interest, and a circle 1304 is defined with radius R around the facility of interest (e.g., warehouse building). The downtime distribution is calculated for major roads and bridges within the circle 1304 defined by R and centered on the point of interest.

A scenario is defined, and a scenario explorer determines the average value and standard deviation of the downtime for the event associated with the scenario. Further, a resilience calculation is performed over the given planning horizon to calculate the average downtime and standard deviation for the event.

In some example embodiments, the resilience calculation is based on the return period for the hazard, while considering the planning horizon. The scenario explorer is for a single event, e.g., an earthquake that happened in the area in the past. In other embodiments, an artificial event is generated, and the scenario explorer estimates the consequences of the artificial event, e.g., downtime for each of the segments and bridges.

The average annual downtime, or the downtime over the planning horizon, is calculated for each road segment and bridge. In some cases, the road segment is defined as the portion of the road between two exits, but other criteria for road segments may also be utilized.

Estimations are performed to determine statistical values on downtime for the road segments and bridges, e.g., average downtime of each segment, average downtime of each segment per mile.

Once the parameters are calculated, the downtime statistics are calculated for the roadways based on the multiple segments and bridges that they may have.

For the resilience calculation, a plurality of estimates is obtained for different return periods and hazard intensities. Then, the annual downtime is calculated as discussed above with reference to FIG. 12.

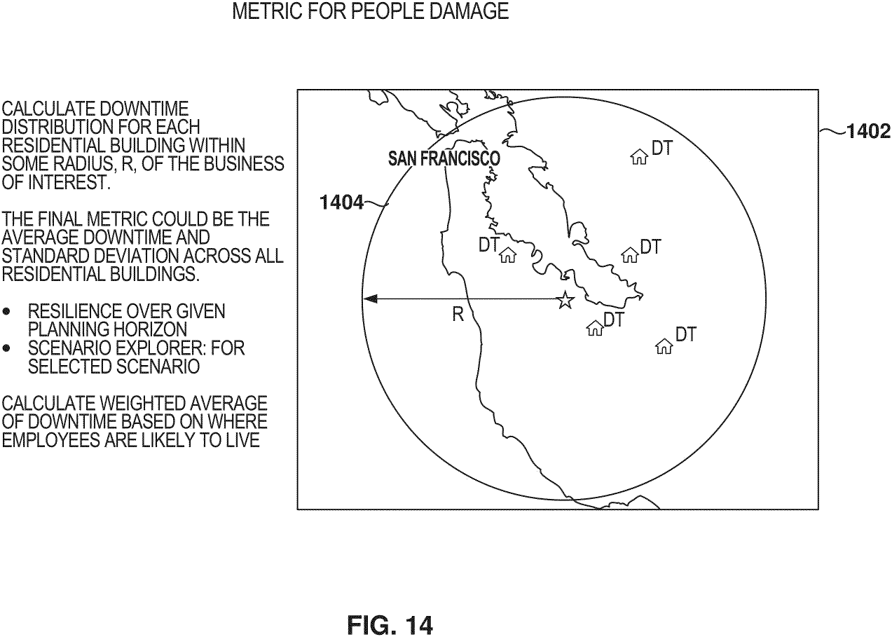

FIG. 14 is an example of calculating downtime for human resources, according to some example embodiments. Map 1402 shows the facility, and in some example embodiments, a circle 1404 with radius R is defined around the facility (e.g., 25 miles, but other values are also possible).

The downtime distribution for each residential building within the circle 1404 is calculated. In some example embodiments, the average downtime and the standard deviation for each of the buildings are estimated.

As described above with reference to FIG. 13, the resilience over the planning horizon is calculated, and a scenario explorer is available for selecting a scenario for possible disaster.

Based on the data about where employees are likely to live, a weighted average of downtime is calculated for the employees that work at the facility.

In some example embodiments, to calculate the residential downtime, two parameters are used: the building functional downtime and the power downtime. Other embodiments may utilize additional or different parameters. The downtime for both parameters is then aggregated to determine residential downtime.

In some example embodiments, a predefined number of residences are selected, and then the downtime is calculated for the selected residences. The average downtime is then calculated for the predefined number of residences and this average downtime then is extrapolated for all the employees. For example, if there are 100 employees, the downtime is calculated as 100 times the average downtime for the calculated average downtime.

In some example embodiments, multiple simulations may be performed by changing the residences selected and estimating the downtime. The final downtime will be the average of the downtime for the multiple simulations.

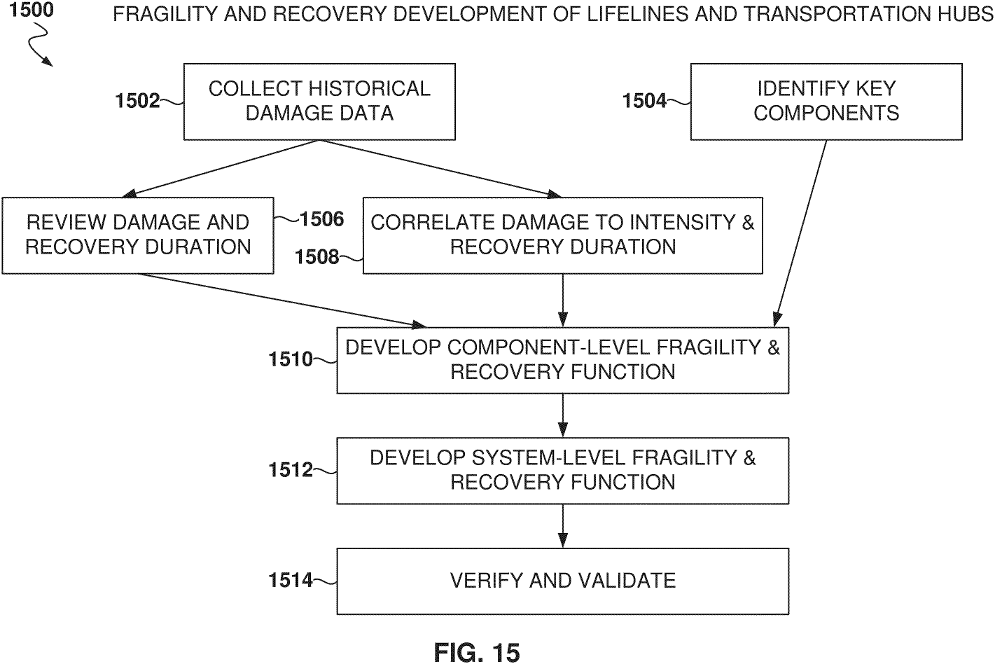

FIG. 15 is a flowchart of a method 1500 for estimating the impact to lifelines after a disaster, according to some example embodiments. While the various operations in this flowchart are presented and described sequentially, one of ordinary skill will appreciate that some or all of the operations may be executed in a different order, be combined or omitted, or be executed in parallel.

At operation 1502, historical damage data is collected, e.g., damage from earthquakes, floods, fires, hurricane, wind, etc. Further, at operation 1504, the key components associated with the disaster are identified, and these key components will be used for the simulations, e.g., calculate fragility and recovery functions.

After operation 1502, operations 1506 and 1508 are performed. At operation 1506, a review of the damage and the recovery functions is performed to analyze how the disaster affected the damage caused (e.g., to buildings) and how long it took for the recovery process to return to full operation.

At operation 1508, the damage collected for the historical events is correlated to the intensity of the event (e.g., shaking volume, water depth) and to the recovery duration.

After operations 1506 and 1508, the method 1500 flows to operation 1510 for developing the fragility and recovery functions for the key components identified at operation 1504.

At operation 1512, fragility and recovery functions are calculated at a system level based on the fragility and recovery functions identified at operation 1510 for the different components.

Further, at operation 1514, the models and functions identified for the estimation of downtime are verified and validated, e.g., by comparing the estimated values to actual values caused by a disaster.

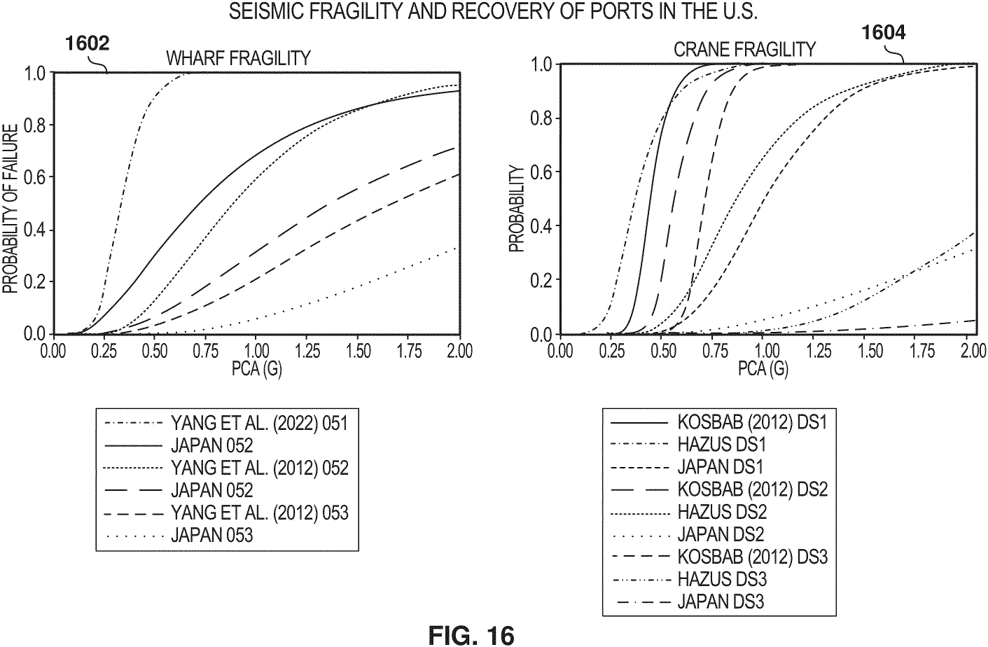

FIG. 16 is an example of the use of fragility functions for shipping ports, according to some example embodiments. To calculate damage metrics for shipping ports and airports, the same process may be used as described with reference to FIGS. 14-15. A circle is defined around the site and downtime is calculated based on assets within the circle.

The damage-estimation process will use different fragility and recovery functions for each asset. For example, functions for airport recovery and port recovery will be different from flood inundation or ground shaking.

Ports include wharves, container cranes, warehouses, offices, cargo-handling vehicles, access roads, and other elements. Each of these elements are vulnerable to disaster, and the vulnerability varies according to the hazard, e.g., cranes are more vulnerable to high winds than offices.

The system identifies these key components and creates fragility and recovery curves. FIG. 16 shows fragility curves 1602 for wharfs and fragility curves 1604 for cranes. Generally, wharfs and container cranes are the important components of the port that are needed for the functionality after an earthquake, and they are vulnerable to earthquakes.

A plurality of fragility curves is presented. Each fragility curve shows the probability of failure as a function of the shaking intensity. In this case, for the wharf fragility functions, a comparison is made of an actual earthquake (Yang et al.) and the calculated estimates (e.g., Japan DS1), where DS1, DS2, and DS3 correspond to three different levels of damage. DS1 is for low damage, DS2 is for intermediate damage, and DS3 is for high damage.

For the crane fragility functions, data from two earthquakes (Kosbab and Hazus) is compared to the estimates (e.g., Japan DS1).

The fragility curves may vary according to geography, since each region has differences in seismicity. In some example embodiments, the U.S. was divided in multiple regions (e.g., four) that have different seismic characteristics.

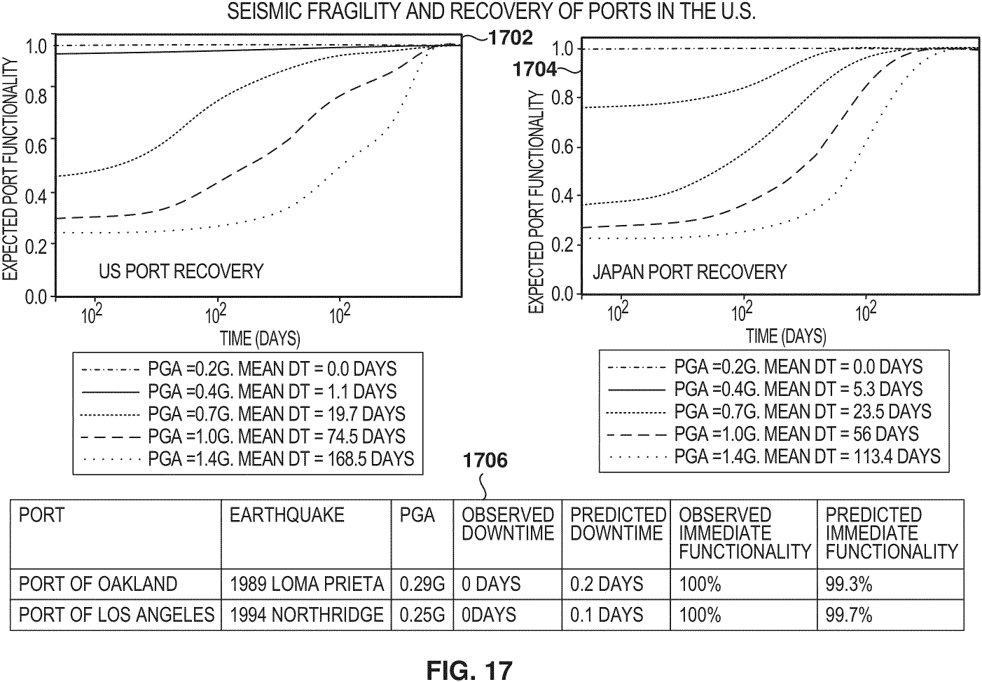

FIG. 17 shows the estimating of recovery times for ports in different countries, according to some example embodiments. The recovery time for a given failure is calculated based on the fragility curves for previous events for the identified components, by combining that fragility function with the recovery given failure curve.

Chart 1702 shows the recovery time, in days, for U.S. ports. Multiple curves are presented according to the ground-shake acceleration: 0.2 g, 0.4 g, 0.7 g, etc. The mean downtime (DT) is provided. The DT is 0.0 days for 0.2 g, 1.1 days for 0.4 g, 19.7 days for 0.7 g, 74.5 days for 1.0 g, and 168.5 days for 1.4 g.

Chart 1704 shows the recovery time, in days, for Japanese ports. A quick comparison shows that U.S. ports recover faster for small earthquakes but recover slower for larger earthquakes. The difference may be attributed to different factors, such as construction type and design requirements: pile-supported in the U.S. and gravity-type in Japan. Also, steel versus concrete. It is noted that the mean downtime is the area above the curve.

Table 1706 shows how the model is validated by comparing the observed downtime with the predicted downtime for two earthquakes in the U.S..

Similar analysis may be performed for airports, by checking on the vulnerabilities of the key components of an airport, such as terminals, control tower, runways, etc.

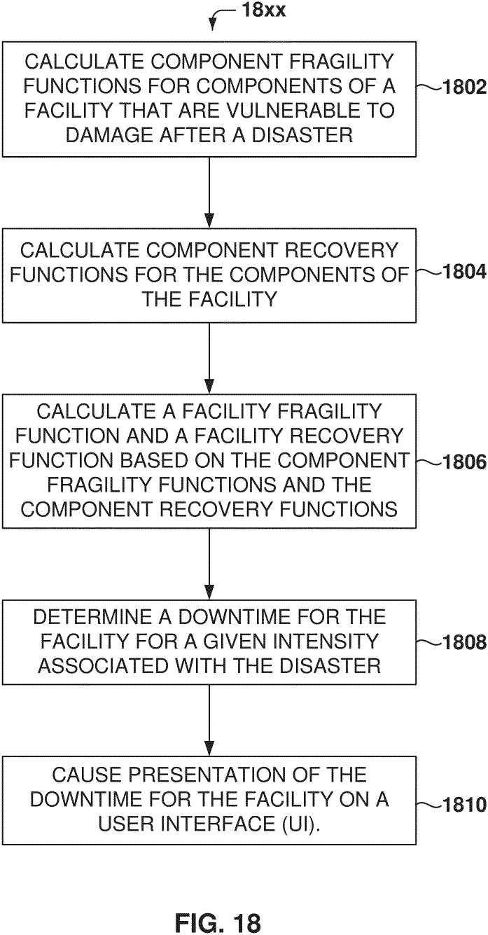

FIG. 18 is a flowchart of a method 1800 for estimating downtime and recovery time after a disaster, according to some example embodiments. While the various operations in this flowchart are presented and described sequentially, one of ordinary skill will appreciate that some or all of the operations may be executed in a different order, be combined or omitted, or be executed in parallel.

Operation 1802 is for calculating, by one or more processors, component fragility functions for components of a facility that are vulnerable to damage after a disaster.

From operation 1802, the method 1800 flows to operation 1804 for calculating, by the one or more processors, component recovery functions for the components of the facility. The component recovery function indicates a probability of recovery after a disaster over time.

At operation 1806, the method 1800 calculates a facility fragility function and a facility recovery function based on the component fragility functions and the component recovery functions;

From operation 1806, the method 1800 flows to operation 1808 for determining, by the one or more processors, a downtime for the facility for a given intensity associated with the disaster.

At operation 1810, the one or more processors cause presentation of the downtime for the facility on a UI.

In one example, the UI provides a first option for selecting a disaster from a group consisting of earthquake, hurricane, and flood, and a second option for selecting a scenario for the disaster.

In one example, the components include infrastructure objects and employees affected by the disaster.

In one example, determining the downtime includes calculating an impact of the disaster on production facilities, demand, supply, and employees.

In one example, the components include roads, and determining downtime further comprises determining downtime for road segments and bridges within a predetermined distance from the facility.

In one example, the facility is a shipping port and the components comprise a wharf and a crane.

In one example, the method 1800 further comprises calculating the facility recovery function for the shipping port for a plurality of values of earthquake shaking.

In one example, the method 1800 further comprises determining an average annual downtime for the facility for a predefined planning period based on a plurality of return periods for the disaster.

In one example, an average downtime for the disaster is based on an area above a recovery curve associated with the facility recovery function.

In one example, the UI includes an option for presenting related facilities that affect recovery time for the facility when the disaster occurs.

Another general aspect is for a system that includes a memory comprising instructions and one or more computer processors. The instructions, when executed by the one or more computer processors, cause the one or more computer processors to perform operations comprising: calculating component fragility functions for components of a facility that are vulnerable to damage after a disaster; calculating component recovery functions for the components of the facility, the component recovery functions indicating a probability of recovery after a disaster over time; calculating a facility fragility function and a facility recovery function based on the component fragility functions and the component recovery functions; determining a downtime for the facility for a given intensity associated with the disaster; and causing presentation of the downtime for the facility on a user interface (UI).

In yet another general aspect, a machine-readable storage medium (e.g., a non-transitory storage medium) includes instructions that, when executed by a machine, cause the machine to perform operations comprising: calculating component fragility functions for components of a facility that are vulnerable to damage after a disaster; calculating component recovery functions for the components of the facility, the component recovery functions indicating a probability of recovery after a disaster over time; calculating a facility fragility function and a facility recovery function based on the component fragility functions and the component recovery functions; determining a downtime for the facility for a given intensity associated with the disaster; and causing presentation of the downtime for the facility on a user interface (UI).

In view of the disclosure above, various examples are set forth below. It should be noted that one or more features of an example, taken in isolation or combination, should be considered within the disclosure of this application.

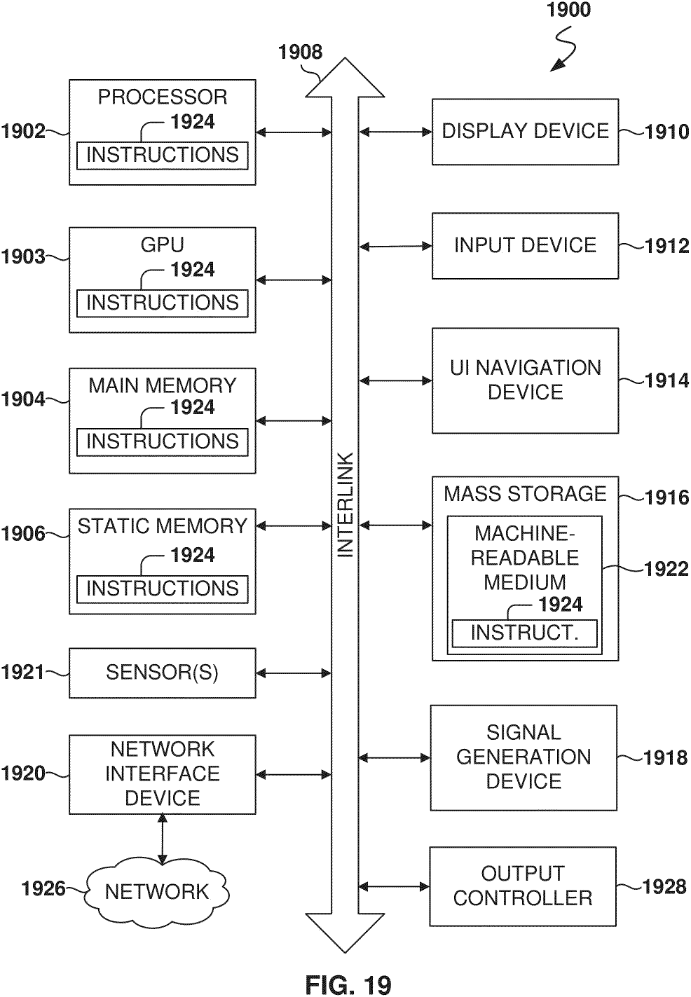

FIG. 19 is a block diagram illustrating an example of a machine 1900 upon or by which one or more example process embodiments described herein may be implemented or controlled. In alternative embodiments, the machine 1900 may operate as a standalone device or may be connected (e.g., networked) to other machines. In a networked deployment, the machine 1900 may operate in the capacity of a server machine, a client machine, or both in server-client network environments. In an example, the machine 1900 may act as a peer machine in a peer-to-peer (P2P) (or other distributed) network environment. Further, while only a single machine 1900 is illustrated, the term "machine" shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1900 may include a hardware processor 1902 (e.g., a central processing unit (CPU), a hardware processor core, or any combination thereof), a graphics processing unit (GPU) 1903, a main memory 1904, and a static memory 1906, some or all of which may communicate with each other via an interlink (e.g., bus) 1908. The machine 1900 may further include a display device 1910, an alphanumeric input device 1912 (e.g., a keyboard), and a user interface (UI) navigation device 1914 (e.g., a mouse). In an example, the display device 1910, alphanumeric input device 1912, and UI navigation device 1914 may be a touch screen display. The machine 1900 may additionally include a mass storage device (e.g., drive unit) 1916, a signal generation device 1918 (e.g., a speaker), a network interface device 1920, and one or more sensors 1921, such as a Global Positioning System (GPS) sensor, compass, accelerometer, or another sensor. The machine 1900 may include an output controller 1928, such as a serial (e.g., universal serial bus (U.S.B)), parallel, or other wired or wireless (e.g., infrared (IR), near field communication (NFC)) connection to communicate with or control one or more peripheral devices (e.g., a printer, card reader).

The mass storage device 1916 may include a machine-readable medium 1922 on which is stored one or more sets of data structures or instructions 1924 (e.g., software) embodying or utilized by any one or more of the techniques or functions described herein. The instructions 1924 may also reside, completely or at least partially, within the main memory 1904, within the static memory 1906, within the hardware processor 1902, or within the GPU 1903 during execution thereof by the machine 1900. In an example, one or any combination of the hardware processor 1902, the GPU 1903, the main memory 1904, the static memory 1906, or the mass storage device 1916 may constitute machine-readable media.

While the machine-readable medium 1922 is illustrated as a single medium, the term "machine-readable medium" may include a single medium, or multiple media, (e.g., a centralized or distributed database, and/or associated caches and servers) configured to store the one or more instructions 1924.

The term "machine-readable medium" may include any medium that is capable of storing, encoding, or carrying instructions 1924 for execution by the machine 1900 and that cause the machine 1900 to perform any one or more of the techniques of the present disclosure, or that is capable of storing, encoding, or carrying data structures used by or associated with such instructions 1924. Nonlimiting machine-readable medium examples may include solid-state memories, and optical and magnetic media. In an example, a massed machine-readable medium comprises a machine-readable medium 1922 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1924 may further be transmitted or received over a communications network 1926 using a transmission medium via the network interface device 1920.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term "or" may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
calculating, by one or more processors, component fragility functions for components of a facility that are vulnerable to damage after a disaster;
calculating, by the one or more processors, component recovery functions for the components of the facility, the component recovery functions indicating a probability of recovery after a disaster over time;
calculating, by the one or more processors, a facility fragility function and a facility recovery function based on the component fragility functions and the component recovery functions;
determining, by the one or more processors, a downtime for the facility for a given intensity associated with the disaster; and
causing, by the one or more processors, presentation of the downtime for the facility on a user interface (UI).

2. The method as recited in claim 1, wherein the UI provides a first option for selecting a disaster from a group consisting of earthquake, hurricane, and flood, and a second option for selecting a scenario for the disaster.

3. The method as recited in claim 1, wherein the components include infrastructure objects and employees affected by the disaster.

4. The method as recited in claim 1, wherein determining the downtime includes calculating an impact of the disaster on production facilities, demand, supply, and employees.

5. The method as recited in claim 1, wherein the components include roads, wherein determining the downtime further comprises:
determining downtime for road segments and bridges within a predetermined distance from the facility.

6. The method as recited in claim 1, wherein the facility is a shipping port and the components comprise a wharf and a crane.

7. The method as recited in claim 6, further comprising:
calculating the facility recovery function for the shipping port for a plurality of values of earthquake shaking.

8. The method as recited in claim 1, further comprising:
determining an average annual downtime for the facility for a predefined planning period based on a plurality of return periods for the disaster.

9. The method as recited in claim 1, wherein an average downtime for the disaster is based on an area above a recovery curve associated with the facility recovery function.

10. The method as recited in claim 1, wherein the UI includes an option for presenting related facilities that affect recovery time for the facility when the disaster occurs.

11. A system comprising:
a memory comprising instructions; and
one or more computer processors, wherein the instructions, when executed by the one or more computer processors, cause the system to perform operations comprising:
calculating component fragility functions for components of a facility that are vulnerable to damage after a disaster;
calculating component recovery functions for the components of the facility, the component recovery functions indicating a probability of recovery after a disaster over time;
calculating a facility fragility function and a facility recovery function based on the component fragility functions and the component recovery functions;
determining a downtime for the facility for a given intensity associated with the disaster; and
causing presentation of the downtime for the facility on a user interface (UI).

12. The system as recited in claim 11, wherein the UI provides a first option for selecting a disaster from a group consisting of earthquake, hurricane, and flood, and a second option for selecting a scenario for the disaster.

13. The system as recited in claim 11, wherein the components include infrastructure objects and employees affected by the disaster.

14. The system as recited in claim 11, wherein determining the downtime includes calculating an impact of the disaster on production facilities, demand, supply, and employees.

15. The system as recited in claim 11, wherein the components include roads, wherein determining the downtime further comprises:
determining downtime for road segments and bridges within a predetermined distance from the facility.

16. A tangible machine-readable storage medium including instructions that, when executed by a machine, cause the machine to perform operations comprising:
calculating component fragility functions for components of a facility that are vulnerable to damage after a disaster;
calculating component recovery functions for the components of the facility, the component recovery functions indicating a probability of recovery after a disaster over time;
calculating a facility fragility function and a facility recovery function based on the component fragility functions and the component recovery functions;
determining a downtime for the facility for a given intensity associated with the disaster; and
causing presentation of the downtime for the facility on a user interface (UI).

17. The tangible machine-readable storage medium as recited in claim 16, wherein the UI provides a first option for selecting a disaster from a group consisting of earthquake, hurricane, and flood, and a second option for selecting a scenario for the disaster.

18. The tangible machine-readable storage medium as recited in claim 16, wherein the components include infrastructure objects and employees affected by the disaster.

19. The tangible machine-readable storage medium as recited in claim 16, wherein determining the downtime includes calculating an impact of the disaster on production facilities, demand, supply, and employees.

20. The tangible machine-readable storage medium as recited in claim 16, wherein the components include roads, wherein determining the downtime further comprises:
determining downtime for road segments and bridges within a predetermined distance from the facility.
